(19) United States
(12) Patent Application Publication
(10) Pub. No.: US 2025/0210645 A1
(43) Pub. Date: Jun. 26, 2025

(54) POSITIVE ELECTRODE ACTIVE MATERIAL FOR LITHIUM PRIMARY BATTERY, AND LITHIUM PRIMARY BATTERY

(71) Applicant: Panasonic Intellectual Property Management Co., Ltd., Kadoma-shi, Osaka (JP)

(72) Inventors: Kohei Saito, OSAKA FU (JP); Masanobu Takeuchi, HYOGO KEN (JP)

(73) Assignee: Panasonic Intellectual Property Management Co., Ltd., Kadoma-shi, Osaka (JP)

(21) Appl. No.: 18/851,963

(22) PCT Filed: Feb. 24, 2023
(86) PCT No.: PCT/JP2023/006870

§ 371 Date: Sep. 27, 2024

(30) Foreign Application Priority Data
Mar. 30, 2022 (JP) 2022-056422

(51) Int. Cl. H01M 4/505; H01M 4/02; H01M 4/131; H01M 4/134; H01M 4/36; H01M 4/40; H01M 6/16

(52) U.S. Cl. CPC H01M 4/505; H01M 4/131; H01M 4/134; H01M 4/366; H01M 4/405; H01M 6/168; H01M 2004/027; H01M 2004/028

(57) ABSTRACT

Disclosed is a positive electrode active material for a lithium primary battery, including: active material particles represented by a composition formula LiₓMnO₂ where 0≤x≤0.05; and a zinc-containing oxide partially covering surfaces of the active material particles. The coverage of the active material particles by the zinc-containing oxide is in the range from 0.10% to 65%.

### TECHNICAL FIELD

The present disclosure relates to a positive electrode active material for a lithium primary battery, and a lithium primary battery using the same.

### BACKGROUND ART

Lithium primary batteries are used for many electronic devices due to their high energy density and low self-discharge. Various lithium primary batteries have hitherto been proposed.

Patent Literature 1 (Japanese Laid-Open Patent Publication No. 2003-249213) discloses “A positive electrode for a lithium primary battery, the positive electrode being characterized in that at least one metal oxide selected from the group consisting of titanium oxide, alumina, zinc oxide, chromium oxide, lithium oxide, nickel oxide, copper oxide, and iron oxide is dispersed between particles of manganese dioxide.”

As a production method of the above-described positive electrode, Patent Literature 1 discloses “A method for producing a positive electrode for a lithium primary battery, the method including steps of: (I) adding, in an organic solvent, manganese dioxide and an alkoxide of at least one metal selected from the group consisting of titanium, aluminum, zinc, chromium, lithium, nickel, copper, and iron, followed by mixing, to produce a liquid mixture; (II) adding water to the liquid mixture, to produce a metal hydroxide; (III) heat-drying a liquid containing the produced metal hydroxide to convert the metal hydroxide into a metal oxide to produce a positive electrode powder in which the metal oxide is dispersed between particles of the manganese dioxide; and (IV) molding the positive electrode powder to produce a positive electrode.

Patent Literature 2 (WO 2001/041247) discloses a non-aqueous electrolyte battery using a non-aqueous electrolyte containing an additive such as phthalimide. An object of the invention described in Patent Literature 2 is: “to prevent formation of a film of an organic substance on a negative electrode surface through chemical reaction during storage of a non-aqueous electrolyte battery at high temperature, thus suppressing an increase in the internal resistance of the primary battery and the secondary battery, and further enhancing the charge-discharge cycle characteristics of a secondary battery.”

### CITATION LIST

### Patent Literatures

Patent Literature 1: Japanese Laid-Open Patent Publication No. 2003-249213
Patent Literature 2: WO 2001/041247

### SUMMARY OF INVENTION

### Technical Problem

When stored at high temperature, a lithium primary battery undergoes a significant increase in resistance and a significant reduction in pulse discharge performance. Under such a circumstance, an object of the present disclosure is to provide a lithium primary battery that can suppress performance degradation (e.g., an increase in resistance and a reduction in pulse discharge performance) due to high-temperature storage, and a positive electrode active material that can be used for the lithium primary battery.

### Solution to Problem

An aspect of the present disclosure relates to a positive electrode active material for a lithium primary battery. The positive electrode active material contains: active material particles represented by a composition formula LiₓMnO₂ where 0≤x≤0.05; and a zinc-containing oxide partially covering surfaces of the active material particles, wherein a coverage of the active material particles by the zinc-containing oxide is in a range from 0.10% to 65%.

An aspect of the present disclosure relates to a lithium primary battery. The lithium primary battery includes: a positive electrode including a positive electrode active material; a negative electrode; and a non-aqueous electrolyte, wherein the positive electrode active material is the positive electrode active material for a lithium primary battery according to the present disclosure, and the negative electrode includes at least one selected from the group consisting of metal lithium and a lithium alloy.

### Advantageous Effects of Invention

According to the present disclosure, it is possible to obtain a lithium primary battery that can suppress performance degradation due to high-temperature storage.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 A diagram schematically showing an example of a lithium primary battery according to an embodiment of the present disclosure.

FIG. 2A A diagram for illustrating a step of a method for evaluating a coverage.

FIG. 2B A diagram for illustrating a step subsequent to the step of FIG. 2A.

FIG. 2C A diagram for illustrating a step subsequent to the step of FIG. 2B.

FIG. 2D A diagram for illustrating a step subsequent to the step of FIG. 2C.

FIG. 3 A graph showing an example of a spectrum measured by EDS analysis.

### DESCRIPTION OF EMBODIMENTS

In the following, embodiments of a lithium primary battery according to the present disclosure will be described by way of examples. However, the present disclosure is not limited to the examples described below. Although examples of specific numerical values and materials may be given in the following description, other numerical values and materials may be used as long as the effects of the present disclosure can be achieved. In the present specification, the expression “from a numerical value A to a numerical value B” includes the numerical value A and the numerical value B, and can be read as “a numerical value A or more and a numerical value B or less”. In the following description, when examples of the lower and upper limits of a numerical value related to a specific physical property, condition, or the like are given, any one of the given examples of the lower limit and any one of the given examples of the upper limit can be freely combined as long as the lower limit is not equal to or not greater than the upper limit. In the following description, the expression “including Z” used in relation to a certain item Z may include a “form including Z and another item”, a “form consisting essentially of Z”, and a “form consisting of Z”.

### (Positive Electrode Active Material)

A positive electrode active material for a lithium primary battery according to the present embodiment contains active material particles (positive electrode active material particles) represented by a composition formula LiₓMnO₂ where 0≤x≤0.05, and a zinc-containing oxide partially covering surfaces of the active material particles. The coverage of the active material particles by the zinc-containing oxide is in the range from 0.10% to 65%. In the following, the active material particles represented by the composition formula LiₓMnO₂ where 0≤x≤0.05 may be referred to as “particles (P1)”. Also, in the following, the particles (P1) covered by the zinc-containing oxide at a coverage of 0.10% to 65% may be referred to as “particles (P2)”. The particles (P2) include the particles (P1), and the zinc-containing oxide disposed on the surfaces of the particles (P1).

As a result of studies, the present inventors have newly found that the performance degradation of a lithium primary battery due to high-temperature storage can be significantly suppressed by setting the above-described coverage in the range from 0.10 to 65%. The present disclosure is based on this new finding.

Although the reason that the above-described effect can be achieved is not clear at present, it is thought that covering the particles (P1) by the zinc-containing oxide can reduce side reactions during high-temperature storage without impeding the forward reaction of the active material. It seems that, as a result, it is possible to suppress an increase in the internal resistance due to high-temperature storage, and a reduction in the low-temperature pulse discharge performance due to high-temperature storage.

The method described in Patent Literature 1 also enables the surfaces of manganese dioxide particles to be covered by a metal oxide. However, with the method according to Patent Literature 1, it is difficult to set the coverage in the above-described range. As a result of studies, the present inventors have found that the above-described coverage can be achieved using a method that is not described in Patent Literature 1. This new method will be described later.

The above-described coverage is 0.10% or more, and may be 0.20% or more, 0.7% or more, 7.0% or more, or 48% or more. The coverage is 65% or less, and may be 61% or less, 48% or less, 25% or less, or 7.0% or less. The coverage is in the range from 0.10 to 65%, and may be in the range from 0.20 to 65%, 0.70 to 65%, 7.0 to 65%, or 48 to 65%. In these ranges, the upper limit may be 61%, 48%, or 7.0% as long as the lower limit is not greater than or equal to the upper limit.

The coverage indicates the proportion of an area of the surfaces of the particles (P1) that is covered by the zinc-containing oxide. The coverage can be measured by a method described in the examples.

As described above, the positive electrode active material contains the active material particles (P1) represented by a composition formula LiₓMnO₂ where 0≤x≤0.05. That is, the particles (P1) have a composition represented by the composition formula. As the active material represented by the composition formula LiₓMnO₂ where 0≤x≤0.05, it is possible to use manganese dioxide, or lithium-doped manganese dioxide. The ratio x of Li may be 0.05 or less in the initial stage of discharge of the lithium primary battery. In general, the ratio x of Li increases with progression of the discharge of the lithium primary battery. Theoretically, the oxidation number of the manganese contained in manganese dioxide is 4. However, as a result of another manganese oxide being incorporated in the positive electrode, or manganese dioxide being doped with lithium, the oxidation number of the manganese may somewhat increase or decrease from 4. Therefore, in LiₓMnO₂, the average oxidation number of the manganese is allowed to somewhat increase or decrease from 4.

The median value of the particle sizes of the particles (P2) may be 10 μm or more and 40 μm or less. When the median value of the particle sizes is in such a range, the generation of gas can be more effectively suppressed in the lithium primary battery, and the current collecting efficiency in the positive electrode is likely to be ensured.

The median value of the particle sizes of the particles (P2) is, for example, a median value of a particle size distribution determined by a quantitative laser diffraction/scattering method (qLD method). For example, LiₓMnO₂ that has been separated from the positive electrode removed from the battery may be used as a measurement sample. For the measurement, SALD-7500nano manufactured by SHIMADZU CORPORATION can be used, for example.

When the surface of the positive electrode active material (particles (P2)) is measured by energy dispersive X-ray analysis, a ratio Iz/Im between a net intensity Iz of a peak around 8.6 keV of Kα radiation of Zn to a net intensity Im of a peak around 5.9 keV of Kα radiation of Mn may be in the range from 0.0001 to 0.08 (e.g., in the range from 0.01 to 0.05). The ratio Iz/Im can be determined by the method described in the examples.

The zinc-containing oxide may be zinc oxide. Examples of the zinc oxide include an oxide represented by ZnO, and an oxide in which the oxygen in the aforementioned oxide is partially defective. The zinc oxide may be ZnO doped with another element (e.g., aluminum, etc.).

The content of the zinc-containing oxide (e.g., zinc oxide) is greater than 0 mass %, and may be 0.05 mass % or more, 0.1 mass % or more, 0.5 mass % or more, or 1.0 mass % or more. The aforementioned content may be 1.5 mass % or less, or 1.0 mass % or less. The aforementioned content may be in the range from 0.05 to 1.5 mass % (e.g., in the range from 0.1 to 1.0 mass %). By setting the aforementioned content to 1.5 mass % or less, the above-described coverage can be easily set in the above-described range.

Part of the zinc-containing oxide may be infiltrated inside the active material particles, to a position at a depth of 15 nm or more from the surfaces of the active material particles (particles (P1)). For example, the zinc-containing oxide may be infiltrated in grain boundaries of the particles (P1). In addition, the particles (P1) may have voids thereinside. For example, when the particles (P1) include secondary particles formed by aggregation of a plurality of primary particles represented by the above-described composition formula, the particles (P1) have voids between the plurality of primary particles. In that case, the zinc-containing oxide may be infiltrated in the voids between the plurality of primary particles. In addition, the zinc-containing oxide may be infiltrated in grain boundaries of the primary particles. That is, the infiltrated zinc-containing oxide may be present in voids between the plurality of primary particles, and/or grain boundaries of the primary particles. Note that when the active material particles (particles (P1)) are the secondary particles constituted by an aggregate of the primary particles, the surfaces of the active material particles refer to the surfaces of the secondary particles.

A depth D (depth from the surfaces of the particles (P1)) that the zinc-containing oxide reaches may be 15 nm or more, or 32 nm or more. The depth D may be 300 nm or less, 200 nm or less, 142 nm or less, or 107 nm or less. The depth D may be in the range from 15 to 300 nm, or in the range from 15 to 200 nm. As a result of the zinc-containing oxide being infiltrated to these depths D, it is possible to achieve a significant effect of enhancing the battery characteristics by covering the manganese dioxide by the zinc-containing oxide, without impairing the battery performance. When the infiltration depth is less than 15 nm, the internal particles cannot be sufficiently protected by the zinc-containing oxide, so that the effect of enhancing the battery characteristics may be reduced. When the infiltration depth is too large, the zinc-containing oxide impedes the forward reaction, so that the effect of enhancing the battery characteristics may be reduced.

### (Production Method of Positive Electrode Active Material)

An example of a production method of a positive electrode active material according to the present embodiment will be described. The production method may be hereinafter referred to as a “production method (M)”. However, the positive electrode active material according to the present embodiment may be produced by a method other than the method described below.

The production method (M) includes a mixing step of mixing particles of manganese dioxide with a material for forming a zinc-containing oxide, to obtain a mixture, and a step of firing the mixture to obtain particles (P2).

Examples of the material (hereinafter may be referred to as a “material (X)”) for forming a zinc-containing oxide through firing include zinc acetate, zinc hydroxide, and zinc carbonate. The amount of addition of the material (X) to the mixture is selected such that the content of the zinc-containing oxide in the particles (P2) has a desired value. For example, the material (X) may be added to the mixture such that the content of the zinc-containing oxide has any of the above-described values when it is assumed that the whole material (X) forms a zinc-containing oxide.

By increasing the proportion of the material (X) in the mixture to the particles (P2), it is possible to increase the coverage of the particles (P1) by the zinc-containing oxide. Therefore, the amount of addition of the material (X) is selected such that the aforementioned coverage has any of the above-described values.

If necessary, the mixture may contain a substance other than the above-described material. For example, the mixture may contain a dispersing medium (water, etc.).

In the firing step, the mixture obtained in the mixing step is fired. Through firing, the surfaces of the particles (P1) are partially covered by the zinc-containing oxide, to obtain particles (P2). The firing is performed under conditions that the material (X) is changed into a zinc-containing oxide. The firing temperature may be in the range from 380 to 450° C. (e.g., in the range from 380 to 420° C.). The firing time may be in the range from 1 to 20 hours (e.g., in the range from 5 to 10 hours).

The particles (P1) may have voids thereinside. For example, when the particles (P1) are secondary particles formed by aggregation of primary particles, the articles (P1) have voids thereinside. When the particles (P1) have voids thereinside, a compound other than manganese dioxide may enter the inside in the process of production and the like. For example, an ammonium salt and the like may be present in the voids inside the particles (P1) (e.g., electrolytic manganese dioxide). Also, the particles (P1) (e.g., electrolytic manganese dioxide) may contain structural water. In the above-described firing step, performing the firing at a high temperature of 380° C. or more will facilitate decomposition and removal of the compound other than manganese dioxide and the structural water that are present inside the particles (P1). As a result, the zinc-containing oxide is likely to be infiltrated in voids resulting from the removal of the compound and the structural water. Therefore, the firing temperature is preferably 380° C. or more. On the other hand, when the heating temperature of the manganese dioxide is 350° C. or less, the above-described decomposition and removal effect is reduced. When the aforementioned temperature is 300° C. or less, the above-described decomposition and removal effect is particularly reduced. Accordingly, when the aforementioned temperature is low, the infiltration depth D of the zinc-containing oxide is reduced.

With the above-described production method, the above-described coverage can be easily set in the above-described range. On the other hand, in the case of using the sol-gel method described in Japanese Laid-Open Patent Publication No. 2003-249213, the formed metal oxide covers most of the surfaces of the particles (P1), so that it is difficult to set the above-described coverage in the above-described range.

With the above-described production method, the zinc-containing oxide can be infiltrated inside the particles (P1) in the process of changing the material (X) into the zinc-containing oxide. By performing the firing at a temperature higher than the melting point of the material (X) such as zinc acetate (melting point: 237° C.), the material (X) melts in the process of firing, and is infiltrated inside the particles (P1). As a result, the zinc-containing oxide can be easily infiltrated inside the particles (P1) to a certain depth.

### (Lithium Primary Battery)

A lithium primary battery according to the present embodiment includes a positive electrode containing a positive electrode active material, a negative electrode, and a non-aqueous electrolyte. The positive electrode active material is the above-described positive electrode active material for a lithium primary battery. The negative electrode contains at least one selected from the group consisting of metal lithium and a lithium alloy.

The non-aqueous electrolyte may contain a non-aqueous solvent and a cyclic imide compound. As will be described in the examples, this constitution can suppress gas generation during high-temperature storage. In addition, this constitution can particularly enhance the effect of suppressing a reduction in the low-temperature pulse discharge voltage due to high-temperature storage. The effect achieved when using the zinc-containing oxide and the cyclic imide compound is higher than the sum of the effect achieved only by covering the active material particles by the zinc-containing oxide and the effect achieved only by using the cyclic imide compound. The reason for this seems to be that some synergistic effect has occurred.

At present, the reason that a reduction in the battery characteristics due to high-temperature storage can be suppressed by using the cyclic imide compound is not clear. However, it is thought that the cyclic imide compound covers part of the surface of the zinc-containing oxide, and suppresses the leaching of the zinc-containing oxide. By suppressing the leaching of the zinc-containing oxide, the effect of the zinc-containing oxide can be maintained high.

When a battery is stored at high temperature, gas is likely to be generated due to decomposition of the components of the non-aqueous electrolyte. On the other hand, in the case of a lithium primary battery, a film derived from the components contained in the electrolytic solution may be formed on the surface of the positive electrode active material. It is thought that as a result of the formation of the film, the decomposition of the non-aqueous electrolyte on the active material surface is suppressed, thus reducing gas generation. However, when the active material surface is covered by a dense film, the internal resistance is increased, resulting in a reduced capacity. Therefore, it is important to balance the suppression of gas generation and the maintenance of battery characteristics. In particular, the film tends to grow during storage of the battery, and it is therefore important that not the entire surface of the active material is covered by the film.

The concentration of the cyclic imide compound in the non-aqueous electrolyte may be 0.05 mass % or more, 0.10 mass % or more, 0.20 mass % or more, or 0.50 mass % or more, and may be 1.5 mass % or less, 1.0 mass % or less, or 0.5 mass % or less. The aforementioned concentration may be in the range from 0.05 to 1.5 mass % (e.g., in the range from 0.10 to 1.0 mass %). By setting the aforementioned concentration to 0.10 mass % or more, a high effect can be achieved. By setting the aforementioned concentration to 1.5 mass % or less, it is possible to suppress a reduction in the characteristics due to the cyclic imide compound excessively covering the particles (P2) of the active material.

A ratio Wz/Wi of a mass Wz of the zinc-containing oxide contained in the positive electrode to a mass Wi of the cyclic imide compound contained in the non-aqueous electrolyte may be 0.5 or more, 0.6 or more, 2.1 or more, 3.0 or more, 5.0 or more, or 6.0 or more, and may be 64 or less, 15 or less, 10 or less, 6.0 or less, or 5.0 or less. The ratio Wz/Wi may be in the range from 0.5 to 15 (e.g., in the range from 0.6 to 10). This constitution can suppress gas generation and performance degradation of the battery due to high-temperature storage. Note that part of the cyclic imide compound contained in the non-aqueous electrolyte is contained in the positive electrode, the negative electrode, and the non-aqueous electrolyte that has been infiltrated in the separator. In a preferred example, the ratio Wz/Wi is in the range from 0.5 to 15 (e.g., in the range from 0.6 to 10), and the content of the zinc-containing oxide in the positive electrode active material is 1.5 mass % or less, and the concentration of the cyclic imide compound in the non-aqueous electrolyte is 1.5 mass % or less.

The cyclic imide compound may be phthalimide. Other examples of the cyclic imide compound will be described later.

Examples of the components of a positive electrode active material and a lithium primary battery according to the present embodiment will be described below. However, the components of the positive electrode active material and the lithium primary battery are not limited to the following examples. Portions other than components essential to the positive electrode active material and the lithium primary battery according to the present embodiment are not particularly limited as long as the effects of the present disclosure can be achieved, and any known components may be used.

The lithium primary battery may include a positive electrode, a negative electrode, a non-aqueous electrolyte, a separator, and an exterior member. The separator is disposed between the positive electrode and the negative electrode. The lithium primary battery may include an electrode group including a positive electrode, a negative electrode, and a separator disposed between the positive electrode and the negative electrode. The electrode group may be a wound electrode group or a stacked electrode group. A wound electrode group is formed by winding a positive electrode, a negative electrode, and a separator such that the separator is disposed between the positive electrode and the negative electrode. A stacked electrode group is formed by stacking a positive electrode, a negative electrode, and a separator such that the separator is disposed between the positive electrode and the negative electrode.

The shape of the lithium primary battery is not particularly limited, and may be prismatic, cylindrical, or coin-shaped. Except for the formation method of the positive electrode active material, the production method of the lithium primary battery is not particularly limited, and any known production method may be used. The lithium primary battery can be produced by accommodating constituent elements (a positive electrode, a negative electrode, a non-aqueous electrolyte, etc.) of the battery in an exterior member (e.g., a battery case).

### (Positive Electrode)

The positive electrode includes a positive electrode mixture. The positive electrode mixture contains a positive electrode active material. The positive electrode may include a positive electrode current collector, and a positive electrode mixture (positive electrode mixture layer) disposed on the positive electrode current collector. Examples of the material of the positive electrode current collector include stainless steel, aluminum, and titanium.

In the case of a coin-shaped battery, a pellet obtained by compression-molding a positive electrode mixture paste, followed by drying, may be used as the positive electrode. Alternatively, the positive electrode may be formed by applying a positive electrode mixture paste onto the positive electrode current collector to form a coating, followed by drying and rolling the coating.

The positive electrode active material includes the above-described positive electrode active material (particles (P2)). The positive electrode may include a positive electrode active material other than the particles (P2). However, the main component (50 mass % or more) of the positive electrode active material is constituted by the particles (P2). Examples of other positive electrode active materials include graphite fluoride. The proportion of the particles (P2) in the positive electrode active material is preferably in the range from 90 mass % to 100 mass %. In a typical example, only the particles (P2) are contained as the positive electrode active material in the positive electrode.

Electrolytic manganese dioxide is suitably used as the manganese dioxide for forming the particles (P1). Electrolytic manganese dioxide that has been subjected to at least one of neutralization treatment, cleaning treatment, and firing treatment as necessary may be used.

The particles (P1) may be secondary particle formed by aggregation of a plurality of primary particles represented by the above-described composition formula. As such particles (P1), commercially available particles may be used, or the particles (P1) may be synthesized using a known method (e.g., an electrolytic method).

In general, electrolytic manganese dioxide is obtained by electrolysis of an aqueous manganese sulfate solution. Accordingly, sulfate ions are inevitably contained in electrolytic manganese dioxide. In a positive electrode mixture produced using such electrolytic manganese dioxide, sulfur atoms are inevitably contained. The amount of the sulfur atoms contained in the positive electrode mixture may be 0.05 parts by mass or more and 3 parts by mass or less, per 100 parts by mass of the manganese atom contained in the positive electrode mixture. When the amount of the sulfur atoms is in such a range, it is though that the sulfate ions interact with unstable M³⁺ produced as a result of intercalation of lithium into MnO₂ in the lithium primary battery, whereby the production of Mn²⁺ due to disproportionation of Mn³⁺ is suppressed. This is thought to suppress the leaching of Mn²⁺ into the non-aqueous electrolyte and the deposition of Mn in the negative electrode. As a result, it is possible to ensure high reliability of the lithium primary battery while securing a high capacity. On the other hand, in the case of a lithium secondary battery, the sulfate ions are partially decomposed in the process of charging, and therefore it is difficult to achieve the above-described effect even if the positive electrode mixture contains sulfates in such an amount that the sulfur atoms are contained in the above-described range. The proportion of the sulfur atoms contained in the positive electrode mixture can be adjusted by adjusting the conditions for cleaning treatment and neutralization treatment. Examples of the cleaning treatment include at least one of water washing treatment and cleaning treatment with acid. Examples of a counteragent used in the neutralization treatment include inorganic bases such as ammonia and a hydroxide.

Adjusting the conditions during electrolytic synthesis can increase the crystallinity of the manganese dioxide, thus reducing the specific surface area of the electrolytic manganese dioxide. The BET specific surface area of LiₓMnO₂ may be 5 m²/g or more and 50 m²/g or less. When the BET specific surface area of LiₓMnO₂ is in such a range, it is possible to easily form a positive electrode mixture layer in a lithium primary battery, while suppressing gas generation more effectively.

The BET specific surface area of LiₓMnO₂ can be measured based on a BET method using a specific surface area measurement apparatus (e.g., manufactured by Mountech Co., Ltd.).

The positive electrode mixture may contain an additive (a binder, a conductive agent, etc.) other than the active material. Examples of the binder include fluorocarbon resin, rubber particles, and acrylic resin. Examples of the conductive agent include a conductive carbon material. Examples of the conductive carbon material include natural graphite, artificial graphite, carbon black, and carbon fibers.

### (Negative Electrode)

The negative electrode may contain metal lithium or a lithium alloy, or may contain both metal lithium and a lithium metal. For example, a composite containing metal lithium and a lithium alloy may be used as the negative electrode.

Examples of the lithium alloy include a Li—Al alloy, a Li—Sn alloy, a Li—Ni—Si alloy, and a Li—Pb alloy. From the viewpoint of securing the discharge capacity and stabilizing the internal resistance, the content of the metal element other than the lithium contained in the lithium alloy is preferably 0.05 to 15 mass %.

Metal lithium, a lithium alloy, or a composite thereof is molded into a desired shape and thickness according to the shape, dimensions, standard performance, and the like of the lithium primary battery.

In the case of a coin-shaped battery, a sheet of metal lithium, a lithium alloy, or a composite thereof that has been punched out into a circular disk shape may be used for the negative electrode. In the case of a cylindrical battery, a sheet of metal lithium, a lithium alloy, or a composite thereof may be used for the negative electrode. The sheet can be obtained by extrusion molding, for example. In the case of a cylindrical battery, a foil of metal lithium or a lithium alloy with a shape having a longitudinal direction and a transverse direction can be used.

In the case of a cylindrical battery, a long tape including a resin substrate and an adhesive layer may be attached to at least one principal surface of the negative electrode along the longitudinal direction of the negative electrode. The width of the tape is, for example, 0.5 mm or more and 3 mm or less. This tape prevents the occurrence of insufficient current collection due to breakage of the negative electrode when the lithium component of the negative electrode is consumed by the reaction at the end of discharge. However, the adhesive strength of the tape is reduced by the electrolytic solution during long-term storage. In the case of using an electrolytic solution containing a cyclic imide compound, this reduction in the adhesive strength can be suppressed, thus making it possible to more effectively prevent the occurrence of insufficient current collection due to breakage of the negative electrode.

As the material of the resin substrate, it is possible to use, for example, polyolefins such as fluorocarbon resin, polyimide, polyphenylene sulfide, polyether sulfone, polyethylene, and polypropylene, and polyethylene terephthalate. Among these, polyolefin is preferred, and polypropylene is particularly preferred.

The adhesive layer contains, for example, at least one component selected from the group consisting of a rubber component, a silicone component, and an acrylic resin component. Specifically, synthetic rubber, natural rubber, and the like may be used as the rubber component. Examples of the synthetic rubber include butyl rubber, butadiene rubber, styrene-butadiene rubber, isoprene rubber, neoprene, polyisobutylene, acrylonitrile-butadiene rubber, a styrene-isoprene block copolymer, a styrene-butadiene block copolymer, and a styrene-ethylene-butadiene block copolymer. An organic compound having a polysiloxane structure, a silicone-based polymer, and the like may be used as the silicone component. Examples of the silicone-based polymer include peroxide-curable silicone and addition reaction-curable silicone. As the acrylic resin component, it is possible to use a polymers containing an acrylic monomer, such as acrylic acid, methacrylic acid, an acrylic acid ester, and a methacrylic acid ester, and examples thereof include a homopolymer or a copolymer of acrylic monomers, such as acrylic acid, methacrylic acid, methyl acrylate, methyl methacrylate, ethyl acrylate, ethyl methacrylate, propyl acrylate, propyl methacrylate, butyl acrylate, butyl methacrylate, octyl acrylate, octyl methacrylate, 2-ethylhexyl acrylate, and 2-ethylhexyl methacrylate. Note that the adhesive layer may contain a crosslinking agent, a plasticizer, a tackifier, and the like.

### (Non-Aqueous Electrolyte)

The non-aqueous electrolyte (non-aqueous electrolytic solution) contains a non-aqueous solvent, and a cyclic imide compound dissolved in the non-aqueous solvent. The non-aqueous electrolyte contains a lithium salt or lithium ions. The cyclic imide compound may be a lithium salt, or may be capable of producing lithium ions. The non-aqueous electrolyte may contain a lithium salt (solute) other than the cyclic imide compound.

### (Cyclic Imide Compound)

Examples of the cyclic imide compound include a cyclic diacylamine. The cyclic imide compound may have a diacylamine ring (also referred to as an imide ring). Another ring (also referred to as a second ring) may be fused to the imide ring. The non-aqueous electrolyte may contain one kind, or two or more kinds of cyclic imide compounds. The cyclic imide compound may be contained in the non-aqueous electrolyte in the state of an imide, or in the form of an anion or a salt. When the cyclic imide compound is contained in the state of an imide in the non-aqueous electrolyte, the cyclic imide compound may be contained in a form having a free NH group, or may be contained in the form of a tertiary amine.

Examples of the second ring include an aromatic ring, and a saturated or unsaturated aliphatic ring. The second ring may contain at least one heteroatom. Examples of the heteroatom include an oxygen atom, a sulfur atom, and a nitrogen atom.

Examples of the cyclic imide constituting the cyclic imide compound include an aliphatic dicarboxylic acid imide, and a cyclic imide having the second ring. Examples of the aliphatic dicarboxylic acid imide include succinimide. Examples of the cyclic imide having the second ring include an imide of aromatic or alicyclic dicarboxylic acid. Examples of the aromatic dicarboxylic acid or the alicyclic dicarboxylic acid include those having a carboxy group on each of the two adjacent atoms constituting the ring. Examples of the cyclic imide having the second ring include phthalimide, and a hydrogenated product of phthalimide. Examples of the hydrogenated product of phthalimide include cyclohex-3-ene-1,2-dicarboximide and cyclohexane-1,2-dicarboximide.

The imide ring may be a N-substituted imide ring having a substituent on the nitrogen atom of the imide. Examples of such a substituent include a hydroxy group, an alkyl group, an alkoxy group, and a halogen atom. Examples of the alkyl group include a C₁₋₄ alkyl group, and the alkyl group may be a methyl group, an ethyl group, and the like. Examples of the alkoxy group include a C₁₋₄ alkoxy group, and the alkoxy group may be a methoxy group, an ethoxy group, and the like. Examples of the halogen atom include a chlorine atom and a fluorine atom.

Among the cyclic imide compounds, phthalimide and N-substituted phthalimide are more preferred. The substituent on the nitrogen atom of the N-substituted phthalimide can be selected from the substituents exemplified for the N-substituted imide ring. It is further preferable to use a cyclic imide compound containing at least phthalimide.

### (Non-Aqueous Solvent)

Examples of the non-aqueous solvent include organic solvents that may be commonly used for non-aqueous electrolytes of lithium primary batteries. Examples of the non-aqueous solvent include ether, ester, and carbonic acid ester. As the non-aqueous solvent, it is possible to use dimethyl ether, γ-butyl lactone, propylene carbonate, ethylene carbonate, 1,2-dimethoxyethane, and the like. The non-aqueous electrolyte may contain one kind, or two or more kinds of non-aqueous solvents.

From the viewpoint of improving the discharge characteristics of the lithium primary battery, the non-aqueous solvent preferably contains a cyclic carbonic acid ester having a high boiling point, and a chain ether having a low viscosity even at low temperatures. The cyclic carbonic acid ester preferably include at least one selected from the group consisting of propylene carbonate (PC) and ethylene carbonate (EC).

### (Lithium Salt)

The non-aqueous electrolyte may contain a lithium salt other than the cyclic imide compound. Examples of the lithium salt include lithium salts used as solutes in lithium primary batteries. Examples of such lithium salts include LiCF₃SO₃, LiClO₄, LiBF₄, LiPF₆, LiRaSO₃ where Ra is a fluorinated alkyl group having 1 to 4 carbon atoms), LiFSO₃, LiN(SO₂Rb)(SO₂Rc) where Rb and Rc are each independently a fluorinated alkyl group having 1 to 4 carbon atoms, LiN(FSO₂)₂, LiPO₂F₂, LiB(C₂O₄)₂, LiBF₂(C₂O₄), LiPF₄(C₂O₄), and LiPF₂(C₂O₄)₂, LiP(C₂O₄)₃. The non-aqueous electrolyte may contain one kind, or two or more kinds of these lithium salts.

The concentration of the lithium ions (the total lithium salt concentration) contained in the non-aqueous electrolyte may be, for example, 0.2 to 2.0 mol/L, and may be 0.3 to 1.5 mol/L.

If necessary, the non-aqueous electrolyte may contain an additive. Examples of the additive include propane sultone and vinylene carbonate. The total concentration of such additives contained in the non-aqueous electrolyte is, for example, 0.003 to 5 mol/L.

### (Separator)

The lithium primary battery usually includes a separator disposed between the positive electrode and the negative electrode. As the separator, a porous sheet made of an insulating material that is resistant to the internal environment of the lithium primary battery may be used. Specific examples thereof include a non-woven fabric made of synthetic resin, a microporous film made of synthetic resin, and laminates thereof.

Examples of the synthetic resin that can be used for the non-woven fabric include polypropylene, polyphenylene sulfide, and polybutylene terephthalate. Examples of the synthetic resin that can be used for the microporous film include polyolefin resin such as polyethylene, polypropylene, and an ethylene-propylene copolymer. The microporous film may contain inorganic particles, as necessary. The thickness of the separator may be m or more and 100 μm or less.

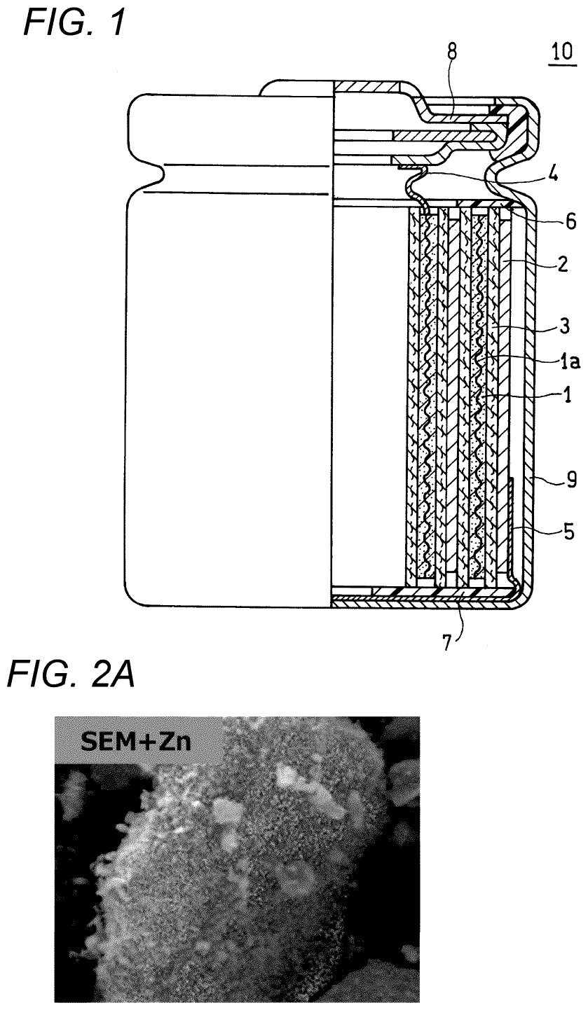

FIG. 1 shows a front view, partly in cross section, of a cylindrical lithium primary battery according to an embodiment of the present disclosure. A lithium primary battery 10 includes an electrode group obtained by winding a positive electrode 1 and a negative electrode 2 with a separator 3 interposed therebetween, and the electrode group is accommodated in a battery case 9 together with a non-aqueous electrolyte (not shown). A sealing plate 8 is mounted to the opening of the battery case 9. A positive electrode lead 4 connected to a current collector 1a of the positive electrode 1 is connected to the sealing plate 8. A negative electrode lead 5 connected to the negative electrode 2 is connected to the battery case 9. In addition, an upper insulating plate 6 and a lower insulating plate 7 are disposed above and below, respectively, the electrode group in order to prevent an internal short circuit. The positive electrode 1 includes a positive electrode mixture layer disposed on the current collector 1a. The positive electrode mixture layer contains the above-described positive electrode active material (particles (P2)). The non-aqueous electrolyte preferably contains the above-described cyclic imide compound.

### EXAMPLES

Hereinafter, the present disclosure will be described specifically with reference to examples. However, the present disclosure is not limited to the following examples.

### Experimental Example 1

In Experimental Example 1, a plurality of positive electrode active materials and a plurality of lithium primary batteries using the positive electrode active materials were produced and evaluated.

### (Production of Positive Electrode Active Material A1)

First, manganese dioxide powder (particles) was prepared. Next, zinc acetate was added to the manganese dioxide powder, and mixed for 10 minutes, to obtain a mixture. At this time, zinc acetate was added such that a predetermined amount of ZnO was contained when zinc acetate was changed into ZnO. The molecular weight of ZnO was about 81.4, and the molecular weight of zinc acetate was about 183.5. Accordingly, a mass of zinc acetate that was 2.25 times (183.5/81.4) the target mass of ZnO was added. In the production of an active material A1, zinc acetate was added such that the content of the formed ZnO was 1.0 mass % of the formed particles (P2).

Next, the above-described mixture was fired for 8.5 hours at 420° C. In this manner, an active material A1 (particles (P2)) was obtained. The active material A1 is constituted by manganese dioxide particles whose surfaces are partially covered by ZnO. The above-described production method of the active material is referred to as method 1.

### (Evaluation of Coverage)

For the active material A1, the coverage by ZnO was measured by energy dispersive X-ray analysis (EDS). Specifically, first, in order to determine EDS measurement points, the surface of the active material A1 was observed with a scanning electron microscope (SU-70 manufactured by Hitachi High-Technologies Corporation). At this time, with the acceleration voltage set at 2 kV, 10 points at which the surface of the active material A1 fitted entirely in a screen were selected under a 5000× field of view. Then, surface analysis by EDS was performed at each of the selected points. The EDS analysis was performed at an acceleration voltage of 15 kV, using an energy dispersive X-ray analyzer (EDAX Genesis manufactured by AMETEK). Next, based on a mapped image of Zn Kα radiation obtained by the surface analysis, the coverage was calculated.

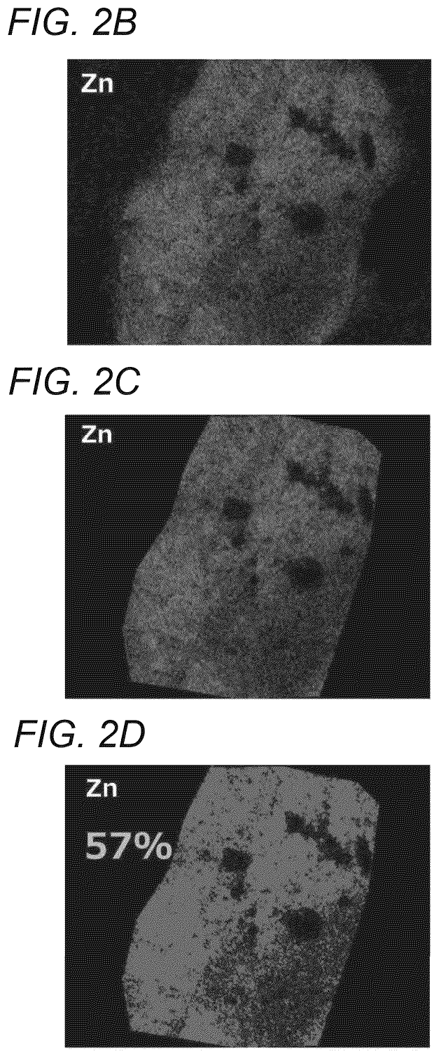

Image analysis software (ImageJ) was used for the calculation of the coverage. FIG. 2A shows an example of an image obtained by superimposing the SEM image and the EDS mapped image of Zn. From the image of FIG. 2A, only the EDS measurement result is extracted to obtain an image shown in FIG. 2B. Next, portions constituting inclined surfaces with a large inclination to the surface of the image in FIG. 2B are cut from the image of FIG. 2B, to obtain an image shown in FIG. 2C. This is done because portions constituting inclined surfaces with a large inclination yield little amount of detection, and do not reflect the actual coverage. Next, the image of FIG. 2C is binarized to obtain an image shown in FIG. 2D. From the image of FIG. 2D, the number of pixels in a portion in which Zn was present was determined. In addition, the number of pixels in a portion in which manganese dioxide particles were present was determined from the total number of pixels in FIG. 2C. At this time, the presence of Mn throughout FIG. 2C was confirmed by EDS analysis. Then, the coverage was calculated by dividing the number of pixels in the portion in which Zn was present by the number of pixels in the portion in which manganese dioxide particles were present. Note that the coverage obtained from the image of FIG. 2D was 57%. This calculation was performed for each of the selected 10 points. Then, the obtained 10 coverages were arithmetically averaged, to obtain a coverage of the active material A1 by ZnO.

### (Evaluation of Ratio Iz/Im)

For the positive electrode active material A1, the ratio Iz/Im of the net intensity Iz of a peak of Kα radiation of Zn to the net intensity Im of a peak of Kα radiation of Mn was determined by energy dispersive X-ray analysis (EDS). Specifically, first, in order to determine EDS measurement points, the surface of the active material A1 was observed using a scanning electron microscope (SU-70 manufactured by Hitachi High-Technologies Corporation). At this time, with the acceleration voltage set at 2 kV, 10 points at which the surface of the active material A1 fitted within a e screen were selected under a 5000× field of view. Then, EDS analysis was performed for each of the selected points.

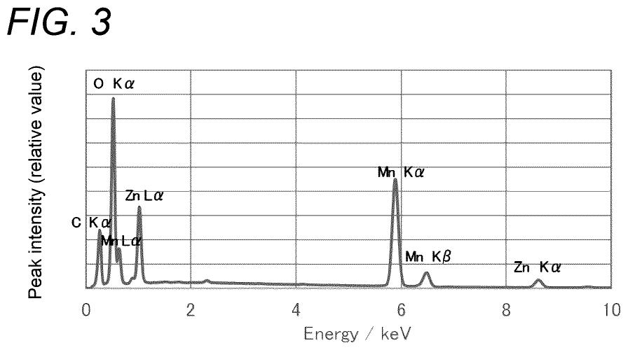

The EDS analysis was performed at an acceleration voltage of 15 kV, using an energy dispersive X-ray analyzer (EDAX Genesis manufactured by AMETEK). An example of the measured spectrum is shown in FIG. 3. From among the obtained peaks, a peak around 8.6 keV of Kα radiation of Zn, and a peak around 5.9 keV of Kα radiation of Mn were selected, and the net intensity Iz of the peak of Kα radiation of Zn, and the net intensity Im of the peak of Kα radiation of Mn were calculated. A net intensity can be obtained by subtracting, from an integral value of a predetermined region of a peak, an integral value of the background of that region, and dividing the result by the measurement time. The aforementioned region was a region 1.1 times the full width at half maximum (FWHM). For each of the selected 10 points, the Iz/Im was obtained, and the value obtained by arithmetically averaging the obtained 10 values of the Iz/Im was determined as the ratio Iz/Im of the active material A1. Note that the peak around 8.6 keV of Kα radiation of Zn was present in the vicinity of 8.6 to 8.7 keV, and the peak top is present in the vicinity of 8.61 keV. The peak around 5.9 keV of Kα radiation of Mn is present in the vicinity of 5.8 to 5.9 keV, and the peak top is present in the vicinity of 5.89 keV.

### (Evaluation of Infiltration Depth of Zinc-Containing Oxide)

For the active material A1, cross sections of the particles were exposed, and scanning transmission electron microscope-electron energy loss spectroscopy (STEM-EELS) of the cross sections of the active material was performed. Through this analysis, the infiltration depth of the zinc-containing oxide in the direction from the surfaces of the active material particles toward the interior of the active material particles was evaluated. Specifically, first, the active material particles (active material A1) were embedded in resin, and the cross sections of the active material particles were exposed by gallium ion focused ion beam processing using a focused ion/electron beam processing and observation apparatus (nanoDUE TNB5000 manufactured by Hitachi High-Technologies Corporation). Then, the vicinity of the surfaces of the active material particles was observed using a STEM apparatus (JEM-ARM200F, a scanning transmission electron microscope equipped with a spherical aberration correction function, manufactured by JEOL Ltd.). At this time, with the acceleration voltage set at 200 kV, and the beam diameter set at 0.1 nm, STEM observation was performed under a 70000× field of view. Then, 10 points at which the surfaces of the active material particles were shown and the interior of the active material particles fitted entirely within a screen were selected. At each of the points, as in the case of the STEM observation, the position at which zinc element was present was analyzed at an acceleration voltage of 200 kV and a beam diameter of 0.1 nm, using an EELS analyzer (GIF Quantum-ER manufactured by Gatan). Through this analysis, the position at which ZnO was present was confirmed. Then, the shortest distance from the surfaces of the active material particles to the most deeply infiltrated ZnO was calculated as the infiltration depth of the zinc-containing oxide within the active material particles. In the calculation of the distance, the distance on the image was calculated using image analysis software (ImageJ), and the actual distance was calculated from the number of pixels of the STEM image and the measurement magnification.

(Production of Positive Electrode Active materials A2 to A5, C1 and C2)

Positive electrode active materials A2 to A5 and C1 and C2 were produced by the same method as the production method (method 1) of the active material A1 except that the amount of addition of zinc acetate was changed such that the content of ZnO had the values shown in Table 1. The obtained active materials were evaluated in the same manner as the active material A1.

### (Production of Positive Electrode Active Material C4)

Into 1000 mL of ethanol, 2.3 g (13 mmol) of zinc isopropoxide (Zn[O(CH₂)₂CH₃]₂) was added, and dissolved by stirring for 30 minutes under atmosphere. Next, 100 g of manganese dioxide powder (particles) was added to the resulting ethanol solution while stirring, to prepare a dispersion. Here, as the manganese dioxide powder, the same power as the manganese dioxide powder used for the production of the active material A1 was used (the same applies to the production of the following active materials).

Next, 25 mL (1.35 mol) of water was added to the above-described dispersion while stirring. Thus, zinc isopropoxide was changed into zinc hydroxide (Zn(OH)₂), to obtain a liquid mixture containing zinc hydroxide. Next, the liquid mixture was heat-dried at 80° C., and further fired for 1 hour at 300° C., to change the zinc hydroxide into zinc oxide. In this manner, powder in which 1 wt % of ZnO was dispersed was obtained. The above-described production method is referred to as method 2.

### (Production of Positive Electrode Active Materials C3 and C5)

Active materials C3 and C5 were produced by the same production method as the production method (method 2) of the active material C4 except that the amounts of addition of the zinc isopropoxide and water to 10 mL of ethanol were changed. The zinc isopropoxide was added such that the content of ZnO had the values shown in Table 1, assuming that the whole of the zinc isopropoxide added was changed into ZnO. The obtained active materials C₃ to C₅ were evaluated in the same manner as the active material A1.

### (Production of Positive Electrode Active Material C6)

A positive electrode active material C6 was obtained by firing manganese dioxide powder (particles) for 8.5 hours at 420° C. The particles of the active material C6 were not covered by ZnO.

### (Production of Battery A1)

Using the active material A1 described above, a battery A1 (lithium primary battery) was produced according to the following procedure.

### (1) Production of Positive Electrode

To 100 parts by mass of the active material A1, 3 parts by mass of Ketjen black (conductive agent) and 5 parts by mass of polytetrafluoroethylene (binder) were mixed, to obtain a positive electrode mixture. The positive electrode mixture was filled into expanded metal (thickness: 0.1 mm) made of stainless steel (SUS 444), dried, and thereafter rolled until the thickness was 0.5 mm. In this manner, a positive electrode plate was obtained. The positive electrode plate was cut into a size of 2 cm×2.5 cm, and a tab lead made of SUS 444 was connected thereto, to obtain a positive electrode.

### (2) Production of Negative Electrode

A metal lithium foil (thickness: 300 m) was cut into a size of 3 cm×4 cm, and a tab lead made of nickel was connect thereto, to obtain a negative electrode.

### (3) Preparation on Non-Aqueous Electrolyte

First, propylene carbonate (PC), ethylene carbonate (EC), and 1,2-dimethoxyethane (DME) were mixed at a volume ratio of 4:2:4, to obtain a non-aqueous solvent. LiCF₃SO₃ was dissolved in this non-aqueous solvent to a concentration of 0.5 mol/L, to prepare a non-aqueous electrolyte.

### (4) Assembly of Battery

A separator was wound on the above-described positive electrode. As the separator, a microporous film (thickness: 25 m) made of polypropylene was used. Next, the positive electrode with the separator wound thereon and the negative electrode were opposed to each other, to obtain an electrode group. The electrode group was placed in a tubular bag (9 cm×6 cm) made of an aluminum laminate film, and the tab lead side of the tubular bag was sealed. Next, 0.5 mL of the non-aqueous electrolyte was injected from an opening on a side opposite to the sealed side, and thereafter the opening was sealed. In this manner, a battery A1 was obtained.

### (Measurement of Discharge Capacity)

For the battery A1, the discharge capacity was measured. Specifically, immediately after being assembled, the battery A1 was discharged to 1.5 V at a constant current of 0.02 C (3.9 mA) in an environment at 25° C., and the discharge capacity was measured. From this discharge capacity, the discharge capacity (mAh/g) per gram of the active material was determined.

(Measurement of Resistance Value after High-Temperature Storage)

For the he battery A1, the resistance value after high-temperature storage was measured by the following method. First, immediately after being assembled, the battery A1 was discharged until 75% of its design capacity was discharged. Thereafter, the battery A1 was stored for 2 months under a high-temperature atmosphere at 70° C. Then, the 1 kHz alternating current resistance value of the battery A1 after high-temperature storage was measured.

(Measurement of Amount of Voltage Drop During Pulse Discharge after High-temperature Storage)

For the battery A1, the amount of voltage drop during pulse discharge at low temperature after high-temperature storage was measured by the following method. First, immediately after being assembled, the battery A1 was discharged until 75% of its design capacity was discharged. Thereafter, the battery A1 was stored for 2 months under a high-temperature atmosphere at 70° C. Then, the battery A1 after high-temperature storage was allowed to stand for 1 hour under an atmosphere at 30° C. Next, an open circuit voltage V0 of the battery A1 was measured, and thereafter a minimum value V1 of the discharge voltage during application of a current of 10.4 mA for 1 second. Then, the difference (V0−V1) between the open circuit voltage V0 and the minimum value V1 was obtained as the amount of voltage drop during pulse discharge.

### (Production of Batteries A2 to A5 and C1 to C6)

Batteries A2 to A5 and C1 to C6 were produced by the same method as the production method of the battery A1 except that the active materials A2 to A5 and C1 to C6 were used in place of the active material A1. The obtained batteries were evaluated by the same method as the method used for the evaluation of the battery A1.

The active materials A1 to A5 and the batteries A1 to A5 are active materials and batteries according to the present disclosure. The active materials C1 to C6 and the batteries C1 to C6 are active materials and batteries according to comparative examples.

Part of the production conditions of the above-described active materials, and the evaluation results of the batteries are shown in Table 1. The discharge capacities are relative values with the discharge capacity of the battery C6 taken as 100. The resistance values after high-temperature storage are relative values with the resistance value of the battery C6 taken as 100. The amounts of voltage drop during pulse discharge are the above-described amounts of voltage drop during pulse discharge after high-temperature storage. The amounts of voltage drop are relative values with the amount of voltage drop of the battery C6 taken as 100. The discharge capacity is preferably high, the resistance value after high-temperature storage is preferably low, and the amount of voltage drop during pulse discharge is preferably low.

TABLE 1

| | | | | | | Battery characteristics | | |
|---|---|---|---|---|---|---|---|---|
| | Covering by ZnO | | | | | | Resistance value | Amount of voltage |
| | | | | | Infiltration | Discharge | after high- | drop during pulse |
| | Formation | Content | Coverage | | depth of ZnO | capacity | temperature storage | discharge |
| Battery | method | (mass %) | (%) | Iz/Im | (nm) | (relative value) | (relative value) | (relative value) |
| A1 | Method 1 | 1.0 | 48 | 0.042 | 107 | 95 | 88 | 86 |
| A2 | Method 1 | 0.1 | 0.70 | 0.0004 | 32 | 99 | 94 | 94 |
| A3 | Method 1 | 0.05 | 0.20 | 0.0001 | 15 | 101 | 96 | 96 |
| A4 | Method 1 | 0.5 | 7.0 | 0.0028 | 73 | 97 | 91 | 90 |
| A5 | Method 1 | 1.5 | 61 | 0.08 | 142 | 92 | 93 | 92 |
| C1 | Method 1 | 0.01 | 0.08 | 0.00007 | 2.0 | 101 | 99 | 98 |
| C2 | Method 1 | 2.0 | 68 | 0.13 | 198 | 89 | 97 | 96 |
| C3 | Method 2 | 0.5 | 71 | 0.09 | 3.0 | 107 | 97 | 99 |
| C4 | Method 2 | 1.0 | 85 | 0.32 | 5.0 | 111 | 114 | 116 |
| C5 | Method 2 | 4.0 | 97 | 1.2 | 10 | 108 | 121 | 127 |

| | | | | | | |
|---|---|---|---|---|---|---|
| C6 | None | — | — | 100 | 100 | 100 |

As shown in Table 1, when the coverage is in the range from 0.10 to 65%, the degradation of characteristics (the resistance value and the voltage during pulse discharge) due to high-temperature storage can be significantly suppressed although the discharge capacity is approximately equivalent to the discharge capacities of the batteries C1 to C6 according to the comparative examples.

### Experimental Example 2

In Experimental Example 2, a plurality of positive electrode active materials and a plurality of lithium primary batteries using the positive electrode active materials were produced and evaluated.

### (Production of Battery B1)

A battery B1 was produced by the same method as the production method of the battery A1 according to Experimental Example 1 except that the non-aqueous electrolyte was changed. The non-aqueous electrolyte of the battery B1 was prepared by adding, to the non-aqueous electrolyte used for the production of the battery A1, phthalimide (PhI) at a concentration of 0.5 mass %.

### (Production of Batteries B2 to B9 and C7 and C8)

Batteries B2 to B9 and C7 and C8 were produced by the same method as the production method of the battery B1 except that the active material and/or the non-aqueous electrolyte was changed. The active materials covered by a zinc-containing oxide, shown in Table 2, were used as the active materials of the batteries B2 to B9. These active materials were produced by the same method as the production method of the active material A1. The same active material (the active material not covered by the zinc-containing oxide) as the active material C6 of Experimental Example 1 was used as the active materials of the batteries C7 and C8. The non-aqueous electrolytes were prepared by adding, to the non-aqueous electrolyte used for the production of the battery A1, phthalimide (PhI) at the concentrations shown Table 2.

For each of the batteries B1 to B9 and C7 and C8 described above, the amount of voltage drop during pulse discharge after high-temperature storage was measured.

(Measurement of Amount of Gas Generation after High-Temperature Storage)

For the battery B1, the amount of gas generation after high-temperature storage was measured by the following method. First, the mass in the atmosphere and the mass in water of the battery B1 were measured, and a volume V0 of the battery B1 was calculated by the Archimedes method. Next, the battery B1 was stored for 2 months under a high-temperature atmosphere at 85° C., and thereafter a volume V1 of the battery B1 after high-temperature storage was measured by the same method as described above. Then, the difference (V1-V0) between the volumes before and after high-temperature storage was obtained as the amount of gas generation after high-temperature storage. The other batteries B2 to B9 and C7 and C8 were evaluated in the same manner.

The batteries B1 to B9 are batteries according to the present disclosure. The batteries C7 and C8 are batteries according to comparative examples.

Part of the production conditions of the above-described active materials, the amount of the additive in the non-aqueous electrolyte, the ratio Wz/Wi, and the evaluation results of the batteries are shown in Table 2. As described above, the ratio Wz/Wi is the ratio of the mass Wz of the zinc-containing oxide contained in the positive electrode to the mass Wi of the cyclic imide compound contained in the non-aqueous electrolyte. The amounts of gas generation after high-temperature storage were relative values with the amount of gas generation of the battery B7 taken as 100. The amounts of voltage drop during pulse discharge shown in Table 2 are the above-described amounts of voltage drop during pulse discharge after high-temperature storage. The amounts of voltage drop are relative values with the amount of voltage drop of the battery B7 taken as 100. The amount of gas generation is preferably low, and the amount of voltage drop during pulse discharge is preferably low.

TABLE 2

| | | | | | | | Battery characteristics | |
|---|---|---|---|---|---|---|---|---|
| | | | | | | | Amount of gas | Amount of voltage |
| | Covering by ZnO | | | Non-aqueous electrolyte | | | generation after high- | drop during pulse |
| | | Content | Coverage | | Concentration | Ratio | temperature storage | discharge |
| Battery | Material | (mass %) | (%) | Additive | (mass %) | Wz/Wi | (relative value) | (relative value) |
| B1 | ZnO | 1.0 | 48 | PhI | 0.5 | 6.0 | 50 | 43 |
| B2 | ZnO | 1.0 | 48 | PhI | 1.0 | 3.0 | 43 | 49 |
| B3 | ZnO | 0.1 | 0.70 | PhI | 0.5 | 0.6 | 70 | 50 |
| B4 | ZnO | 0.5 | 7.0 | PhI | 0.5 | 3.0 | 67 | 46 |
| B5 | ZnO | 1.5 | 61 | PhI | 0.5 | 10 | 42 | 48 |
| B6 | ZnO | 1.5 | 61 | PhI | 1.0 | 5.0 | 34 | 52 |
| B7 | ZnO | 1.0 | 48 | None | 0.0 | — | 100 | 100 |
| C7 | None | | | PhI | 0.5 | 0.0 | 78 | 58 |
| C8 | None | | | None | 0.0 | — | 121 | 133 |
| B8 | ZnO | 1.0 | 48 | PhI | 0.05 | 64 | 94 | 97 |
| B9 | ZnO | 1.0 | 48 | PhI | 1.5 | 2.1 | 36 | 62 |

As can be clearly seen from comparison between batteries B1, B2, and B7 to B9, the addition of phthalimide to the non-aqueous electrolyte can significantly reduce the amount of gas generation after high-temperature storage and the voltage drop during pulse discharge. As can be clearly seen from comparison between the batteries B1, B7, C7, and C8, the effect achieved when using the zinc-containing oxide and the cyclic imide compound is higher than the sum of the effect achieved only by covering the active material particles by the zinc-containing oxide and the effect achieved only by using the cyclic imide compound. The reason for this is presumably that, in addition to the effect achieved by the addition of the phthalimide, the film formed by the phthalimide prevents the leaching of the zinc-containing oxide during high-temperature storage, so that the effect of the zinc-containing oxide is less likely to be compromised.

### INDUSTRIAL APPLICABILITY

The present disclosure is applicable to a positive electrode active material for lithium primary battery, and a lithium primary battery.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

1 Positive electrode
1a Positive electrode current collector
2 Negative electrode
3 Separator
4 Positive electrode lead
5 Negative electrode lead
8 Sealing plate
9 Battery case
10 Lithium primary battery

1. A positive electrode active material for a lithium primary battery, comprising:
active material particles represented by a composition formula LiₓMnO₂ where 0≤x≤0.05; and
a zinc-containing oxide partially covering surfaces of the active material particles, wherein
a coverage of the active material particles by the zinc-containing oxide is in a range from 0.10% to 65%.

2. The positive electrode active material for a lithium primary battery according to claim 1, wherein, when a surface of the positive electrode active material is measured by energy dispersive X-ray analysis, a ratio Iz/Im of a net intensity Iz of a peak around 8.6 keV of Kα radiation of Zn to a net intensity Im of a peak around 5.9 keV of Kα radiation of Mn is in a range from 0.0001 to 0.08.

3. The positive electrode active material for a lithium primary battery according to claim 1, wherein the zinc-containing oxide is zinc oxide.

4. The positive electrode active material for a lithium primary battery according to claim 1, wherein a content of the zinc-containing oxide is 1.5 mass % or less.

5. The positive electrode active material for a lithium primary battery according to claim 1, wherein part of the zinc-containing oxide is infiltrated inside the active material particles, to a position at a depth from 15 nm or more from the surfaces of the active material particles.

6. A lithium primary battery comprising:
a positive electrode including a positive electrode active material;
a negative electrode; and
a non-aqueous electrolyte, wherein
the positive electrode active material is the positive electrode active material for a lithium primary battery according to claim 1, and
the negative electrode includes at least one selected from the group consisting of metal lithium and a lithium alloy.

7. The lithium primary battery according to claim 6, wherein the non-aqueous electrolyte includes a non-aqueous solvent and a cyclic imide compound.

8. The lithium primary battery according to claim 7, wherein a ratio Wz/Wi of a mass Wz of the zinc-containing oxide included in the positive electrode to a mass Wi of the cyclic imide compound included in the non-aqueous electrolyte is in a range from 0.5 to 15.

9. The lithium primary battery according to claim 7, wherein a concentration of the cyclic imide compound in the non-aqueous electrolyte is 1.5 mass % or less.

10. The lithium primary battery according to claim 7, wherein the cyclic imide compound is phthalimide.
